(19) United States
(12) Patent Application Publication
(10) Pub. No.: US 2019/0172086 A1
(43) Pub. Date: Jun. 6, 2019

(54) DYNAMIC PROMOTION RATE BASED ON LOCATION-BASED METRICS

(71) Applicant: INTERNATIONAL BUSINESS MACHINES CORPORATION, ARMONK, NY (US)

(72) Inventors: Lisa Seacat DeLuca, Baltimore, MD (US); Jeremy A. Greenberger, San Jose, CA (US); Zachary M. Greenberger, San Jose, CA (US); Jana H. Jenkins, Raleigh, NC (US)

(21) Appl. No.: 15/833,554

(22) Filed: Dec. 6, 2017

(51) Int. Cl. G06Q 30/02; G06Q 50/00; H04W 4/021; H04W 4/20

(52) U.S. Cl. CPC G06Q 30/0224; G06Q 30/0233; G06Q 50/01; H04W 4/021; G06Q 30/0239; G06Q 30/0261; G06Q 30/0267; G06Q 30/0277; H04W 4/206

(57) ABSTRACT

The method of sending notifications may include determining that a user has interacted with a location in a manner that meets a set of criteria. The method may include based, at least in part, on a determination that the user has interacted with the location, determining content of a notification for the user based in part on the user meeting the set of criteria in an implementation of a location-based information campaign. The method may include determining a value included in the content of the notification based, at least in part, on a location history of the user. The method may include sending the notification to a computing device of the user.

### TECHNICAL FIELD

The present invention relates to sending customized notifications based on location based information.

### BACKGROUND

In many businesses, an important attribute of success is building true customer loyalty. Everything changes when a customer becomes loyal. When a customer becomes truly loyal, a vendor offers more than a just commodity, but also a personal relationship between the customer and the products and/or service. A major threat to businesses is the perception by customers that all a business offers is a replaceable, interchangeable commodity. This hazard stalks businesses every move. Companies and/or organizations of any size may build wealth and stability through customer loyalty. Businesses with loyal customers grow faster than other businesses when times are good, and they have the most breathing room when times are bad. There is a long felt need for systems that can dynamically and/or in real time offer promotional discount rates at optimal circumstances in highly competitive markets, which has traditionally been challenging based on difficulties of detecting potential customer's interests in products and/or services for sale.

### SUMMARY

Embodiments relate to a method of sending notifications. The method may include determining that a user has interacted with a location in a manner that meets a set of criteria. The method may include based, at least in part, on a determination that the user has interacted with the location, determining content of a notification for the user based in part on the user meeting the set of criteria in an implementation of a location-based information campaign. The method may include determining a value included in the content of the notification based, at least in part, on a location history of the user. The method may include sending the notification to a computing device of the user.

### BRIEF DESCRIPTION OF THE DRAWINGS

FIG. 1 illustrates a schematic view of a communications system, in accordance with embodiments of the present invention.

FIG. 2 illustrates an example functional block diagram of a mobile electronic device that may be used for micro-location push notification (MLPN) processing, in accordance with embodiments of the present invention.

FIG. 3 illustrates an example mobile device receiving an initial push notification, in accordance with embodiments of the present invention.

FIG. 4 illustrates an example mobile device receiving another push notification based on another micro-location, in accordance with embodiments of the present invention.

FIG. 5 illustrates an example mobile device receiving a second push notification based on an action with the mobile device and yet another micro-location, in accordance with embodiments of the present invention.

FIG. 6 illustrates an example process of sending a customized notification based on location based information, in accordance with embodiments of the present invention.

FIG. 7 depicts a cloud computing environment according to embodiments of the present invention.

FIG. 8 depicts abstraction model layers according to embodiments of the present invention.

FIG. 9 illustrates a computer system used for implementing the methods associated with embodiments of the present invention.

### DETAILED DESCRIPTION

Embodiments relate to a determination of which promotion discount rate a user and/or potential customer may get upon entering a targeted notification area. Embodiments relate to a system and method to personalize the promotion rate of notifications to a mobile device of the user and/or potential customer based on various location factors. Embodiments relate to dynamic notifications.

For example, a venue may use a customer analysis system (e.g. IBM Presence Insights and/or IBM Marketing Cloud). A venue operator may log into the management console, as an example interface. The venue operator and/or marketing software may create location-based campaigns. The venue operator and/or marketing software may define a range of rates that would be offered to the customers (e.g. save 10% to 30%). The venue operator and/or marketing software may generate/save a notification along with the rate range placeholder (e.g. “Thanks for shopping at Macy's, Here is a {{DETERMINED_RATE}}% discount on clothing!”). The venue operator and/or marketing software may generate/save the notification a single time or multiple times for each offer notification that is desired to be communication to potential customers.

For example, a potential customer may be walking around a particular venue (e.g. a Macy's department store). The potential customer may enter a targeted notification area and/or location (e.g. a geofence, a beacon, and/or similar system). In embodiments, a system may determine the promotional rate in which the person should receive based on location specific metrics. In embodiments, promotional rates may be dynamically changed and/or offered based on how a user and/or potential customer interacts with the targeted notification area.

In embodiments, a system may determine a rate in which to give and/or offer a user and/or potential customer based on location specific information. Embodiments relate to non-limiting examples of: location history (e.g. the number of times a targeted notification area is visited, etc.); amount of people a potential customer has referred to the store that visited the venue using location data; based on the number of times the user has breached a zone (e.g. entered women's shoes department five times); whether or not the person has already redeemed an offer in a time period (e.g. today, within the past five hours, the past week, etc.); what the person is wearing at the time of the visit (e.g. using enabling clothing detection technology).

In embodiments, a system may send a mobile device of a potential customer a notification with a proper promotional/discount rate that maximizes the possibility of promoting a sale of a good or service. The proper promotional/discount rate may utilize location specific information about the potential customer to determine the proper promotional/discount rate.

In embodiments, a system may determine and/or transmit a uniform promotional rate to a plurality of customers based on grouping of customers. For example, customers may be grouped based on awards programs, consuming habits, and/or social networks. For example, a uniform promotional rate to a plurality of customers in the same social network (e.g. determined by social media relationships or other reference data) may avoid negative customer experiences. An example negative customer experience which vendors may wish to avoid is that different potential customers in the same social network fighting over which device's coupon to use and/or a potential customer feeling shunning by a vendor because they have a different promotional rate than their friend.

Embodiments relate to a method of sending notifications. The method may include determining that a user has interacted with a location in a manner that meets a set of criteria. The method may include based, at least in part, on a determination that the user has interacted with the location, determining content of a notification for the user based in part on the user meeting the set of criteria in an implementation of a location-based information campaign. The method may include determining a value included in the content of the notification based, at least in part, on a location history of the user. The method may include sending the notification to a computing device of the user.

In embodiments, the location history of the user comprises a number of times the user has entered the location within a first time period. In embodiments, the location history of the user comprises a timestamp that indicates a promotion offer was redeemed by the user.

In embodiments, the location history of the user comprises an object in possession of the user when they entered the location. In embodiments, the object in possession of the user and an indicator of the user's shopping habits. In embodiments, the object in possession is at least one of: clothes; accessories; fashion items; consumer goods; consumables; and combinations thereof.

In embodiments, the location history of the user comprises characteristics of a group of users that includes the user. In embodiments, the characteristics of the group of users is used in the determining the content of the notification. In embodiments, the content of the notification is uniform across the group of users. In embodiments, the content of the notification is harmonized across the group of users.

In embodiments, the content of the location-based information campaign is based on a customer award program. In embodiments, the content of the location-based information campaign is based on consuming habits of the group of users. In embodiments, the content of the location-based information campaign is based on social media data of the group of users. In embodiments, the location history comprises a number of people the user has referred to a venue.

In embodiments, the location is a targeting notification area.

In embodiments, the notification is personalized to the user based on the location history of the user. In embodiments, the notification is personalized to include a discount rate determined at least in part on the location history of the user. In embodiments, the location includes a customer analysis system configured to at least partially generate the location history of the user.

Embodiments relate to a computer system including: a central processing unit (CPU); a memory coupled to the CPU; and a computer readable storage device coupled to the CPU, the storage device containing instructions that are executed by the CPU via the memory to implement a method that determines an optimal number of data centers for an application.

Embodiments relate to a computer program product, comprising a computer readable hardware storage device having computer readable program code stored therein. The program code may contain instructions executable by one or more processors of a computer system to implement a method of assessing damage to an object.

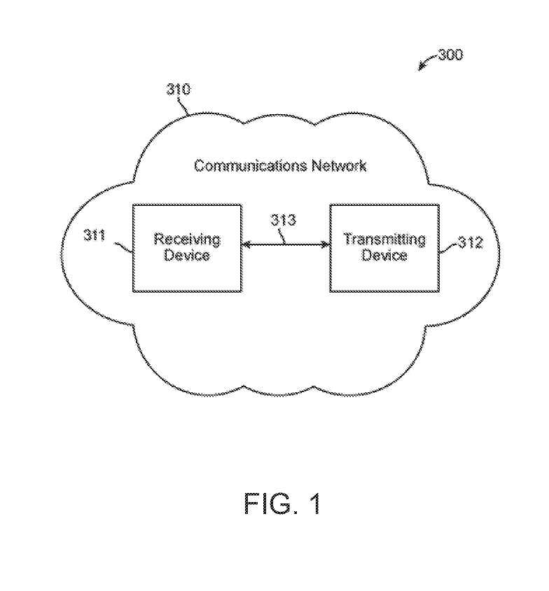

FIG. 1 is a schematic view of a communications system 300, in accordance with example embodiments. Communications system 300 may include a communications device that initiates an outgoing communications operation (transmitting device 312) and a communications network 310, which transmitting device 312 may use to initiate and conduct communications operations with other communications devices within communications network 310. For example, communications system 300 may include a communication device (receiving device 311) that receives the communications operation from the transmitting device 312. Although communications system 300 may include multiple transmitting devices 312 and receiving devices 311, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 310. Communications network 310 may be capable of providing communications using any suitable communications protocol. The transmitting device 312 and receiving device 311, when located within communications network 310, may communicate over a bidirectional communication path such as path 313, or over two unidirectional communication paths. Both the transmitting device 312 and receiving device 311 may be capable of initiating a communications operation and receiving an initiated communications operation.

The transmitting device 312 and receiving device 311 may include any suitable device for sending and receiving communications operations. For example, the transmitting device 312 and receiving device 311 may include mobile telephone devices, television systems, cameras, camcorders, a device with audio video capabilities, tablets, wearable devices, other smart devices, and any other device capable of communicating wirelessly (with or without the aid of a wireless-enabling accessory system) or via wired pathways (e.g., using traditional telephone wires). The communications operations may include any suitable form of communications, including for example, voice communications (e.g., telephone calls), data communications (e.g., e-mails, text messages, media messages), video communication, communications with calendaring applications, or combinations of these (e.g., video conferences).

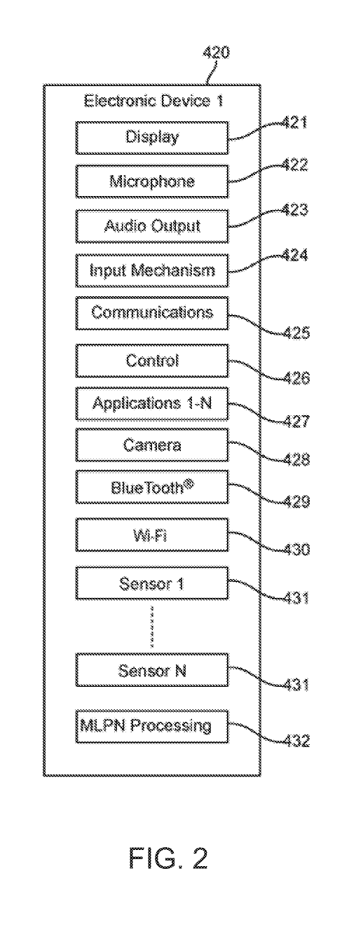

FIG. 2 illustrates an example functional block diagram of a mobile electronic device 420 that may be used for micro-location push notification (MLPN) processing 432, according to one embodiment. Both the transmitting device 312 (FIG. 1) and receiving device 311 may include some or all of the features of the electronics device 420. In embodiments, the electronic device 420 may comprise a display 421, a microphone 422, an audio output 423, an input mechanism 424, communications circuitry 425, control circuitry 426, Applications 1-N 427 (e.g., a calendaring application), camera 428, a BLUETOOTH® interface 429, a Wi-Fi interface 430 and sensors 1 to N 431 (N being a positive integer), MLPN processing 432 (e.g., MLPN processing using one or more processors, BLUETOOTH® data (e.g., BLUETOOTH® low energy (BLE) beacon information), sensor data, Wi-Fi triangulation information, IoT data, etc.) and any other suitable components. In embodiments, applications 1-N 427 are provided and may be obtained from a cloud or server via a communications network 410, etc., where N is a positive integer equal to or greater than 1.

In embodiments, some or all of the applications employed by the audio output 423, the display 421, input mechanism 424, communications circuitry 425, and/or the microphone 422 may be interconnected and managed by control circuitry 426. For example, in embodiments, a handheld music player capable of transmitting music to other tuning devices may be incorporated into the electronics device 420.

In embodiments, the audio output 423 may include any suitable audio component for providing audio to the user of electronics device 420. For example, in embodiments, audio output 423 may include one or more speakers (e.g., mono or stereo speakers) built into the electronics device 420. In some embodiments, the audio output 423 may include an audio component that is remotely coupled to the electronics device 420. For example, the audio output 423 may include a headset, headphones, or earbuds that may be coupled to communications device with a wire (e.g., coupled to electronics device 420 with a jack) or wirelessly (e.g., BLUETOOTH® headphones or a BLUETOOTH® headset).

In embodiments, the display 421 may include any suitable screen or projection system for providing a display visible to the user. For example, display 421 may include a screen (e.g., an LCD, LED, etc. screen) that is incorporated in the electronics device 420. Display 421 may be operative to display content (e.g., information regarding communications operations or information regarding available media selections) under the direction of control circuitry 426.

In embodiments, input mechanism 424 may be any suitable mechanism or user interface for providing user inputs or instructions to electronics device 420. Input mechanism 424 may take a variety of forms, such as a button, keypad, dial, a click wheel, or a touch screen. The input mechanism 424 may include a multi-touch screen.

In embodiments, communications circuitry 425 may be any suitable communications circuitry operative to connect to a communications network (e.g., communications network 310, FIG. 1) and to transmit communications operations and media from the electronics device 420 to other devices within the communications network. Communications circuitry 425 may be operative to interface with the communications network using any suitable communications protocol such as, for example, Wi-Fi (e.g., an IEEE 802.11 protocol), BLUETOOTH®, high frequency systems (e.g., 900 MHz, 2.4 GHz, and 5.6 GHz communication systems), infrared, GSM, GSM plus EDGE, CDMA, quadband, and other cellular protocols, VOW, TCP-IP, or any other suitable protocol.

In embodiments, communications circuitry 425 may be operative to create a communications network using any suitable communications protocol. For example, in embodiments, communications circuitry 425 may create a short-range communications network using a short-range communications protocol to connect to other communications devices. For example, communications circuitry 425 may be operative to create a local communications network using the Bluetooth® protocol to couple the electronics device 420 with a BLUETOOTH® headset.

In embodiments, control circuitry 426 may be operative to control the operations and performance of the electronics device 420. Control circuitry 426 may include, for example, one or more processors, a bus (e.g. for sending instructions to the other components of the electronics device 420), memory, storage, or any other suitable component for controlling the operations of the electronics device 420. In embodiments, a processor may drive the display and process inputs received from the user interface. The memory and storage may include, for example, cache, Flash memory, ROM, and/or RAM/DRAM. In embodiments, memory may be specifically dedicated to storing firmware (e.g. for device applications such as an operating system, user interface functions, and processor functions). In some embodiments, memory may be operative to store information related to other devices with which the electronics device 420 performs communications operations (e.g., saving contact information related to communications operations or storing information related to different media types and media items selected by the user).

In one embodiment, the control circuitry 426 may be operative to perform the operations of one or more applications implemented on the electronics device 420. Any suitable number or type of applications may be implemented. Although the following discussion will enumerate different applications, it will be understood that some or all of the applications may be combined into one or more applications. For example, the electronics device 420 may include a calendaring application (e.g., MICROSOFT® OUTLOOK®, GOOGLE® Calendar, etc.), an automatic speech recognition (ASR) application, a dialog application, a map application, a media application (e.g., QuickTime, MobileMusic.app, or MobileVideo.app), social networking applications (e.g., FACEBOOK®, TWITTER®, INSTAGRAM®, etc.), an Internet browsing application, etc. In embodiments, the electronics device 420 may include one or multiple applications operative to perform communications operations. For example, in embodiments, the electronics device 420 may include a messaging application, a mail application, a voicemail application, an instant messaging application (e.g. for chatting), a videoconferencing application, a fax application, or any other suitable applications for performing any suitable communications operation.

In embodiments, the electronics device 420 may include a microphone 422. For example, in embodiments, electronics device 420 may include microphone 422 to allow the user to transmit audio (e.g., voice audio) for speech control and navigation of applications 1-N 427, during a communications operation or as a means of establishing a communications operation or as an alternative to using a physical user interface. The microphone 422 may be incorporated in the electronics device 420, or may be remotely coupled to the electronics device 420. For example, the microphone 422 may be incorporated in wired headphones, the microphone 422 may be incorporated in a wireless headset, the microphone 422 may be incorporated in a remote control device, etc.

In embodiment, the camera 428 comprises one or more camera devices that include functionality for capturing still and video images, editing functionality, communication interoperability for sending, sharing, etc., photos/videos, etc.

In embodiments, the BLUETOOTH® interface 429 comprises processes and/or programs for processing BLUETOOTH® information, and may include a receiver, transmitter, transceiver, etc.

In embodiments, the electronics device 420 may include multiple sensors 1 to N 431, such as accelerometer, gyroscope, microphone, temperature, light, barometer, magnetometer, compass, radio frequency (RF) identification sensor, global positioning system (GPS), Wi-Fi, etc. In one embodiment, the multiple sensors 1-N 431 provide information to the RRC processing 432. In embodiments, the multiple sensors 1-N 431 may be aggregated or used from different electronic devices, such as an electronic device 420 (e.g., a smartphone) and another electronic device 420 (e.g., a wearable device such as a smartwatch). For example, a gyroscope sensor and/or a temperature may be used from a wearable device, and a microphone sensor may be used from a smartphone.

In embodiments, the electronics device 420 may include any other component suitable for performing a communications operation. For example, in embodiments, the electronics device 420 may include a power supply, ports, or interfaces for coupling to a host device, a secondary input mechanism (e.g., an ON/OFF switch), or any other suitable component.

One drawback to current location-based notification technology is that a user might not be actively engaged with their mobile device during their entire shopping experience, or it may take time for a notification to transmit to their device. However, in the case of micro-location targeted offers these push messages need to feel real-time and relatable for the user. In one embodiment, the MLPN processing 432 provides the following processing with devices and applications (or apps) 1-N 427 electronic device 420, along with any required communication with a cloud computing environment 50, network 310, etc. In one embodiment, real-time impression push notifications based on indoor micro-locations are provided.

In embodiments, a marketer defines a push message program, campaign, etc. using known technologies. It should be noted that a program or campaign is optional, and there are a number of use cases where a push notification is triggered without being part of a program or campaign. The marketer leaves aspects of the message as parameters to be filled out on the client device (e.g., a mobile device 420) as information about the user changes.

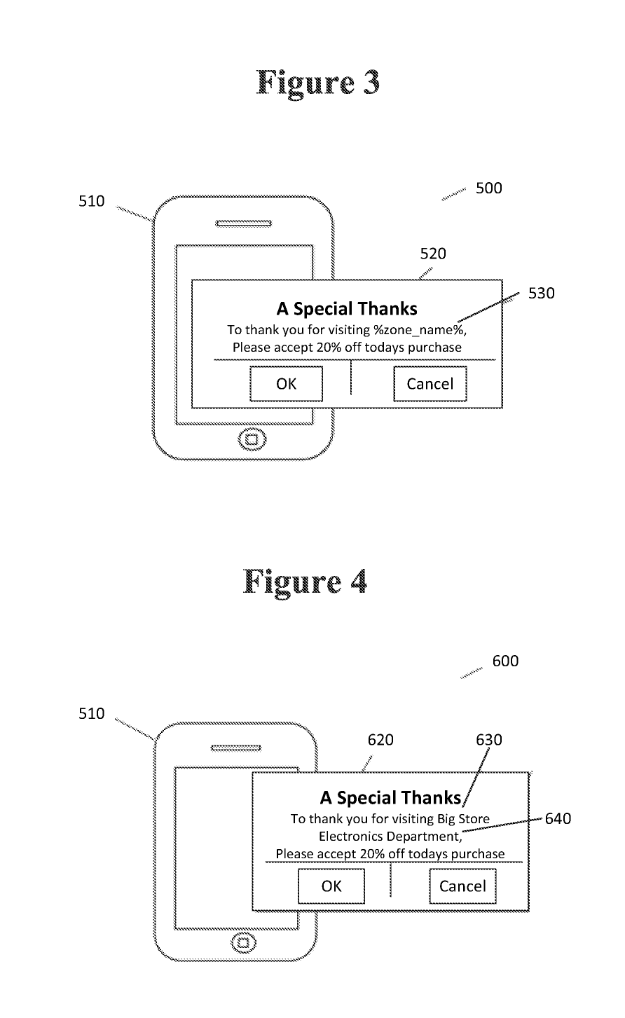

FIG. 3 illustrates an example mobile device 510 receiving an initial push notification 520, according to an embodiment. In this example, the mobile device 510 is with a user that is visiting a retail establishment, “Big Store.” The mobile device 510 receives an initial push notification 520 that may have the example message “A Special Thanks; To thank you for visiting % zone_name % 530 (the placeholder for the current zone the mobile device visits), please accept 20% off todays purchases.” The user may select OK or Cancel on the push notification 520.

FIG. 4 shows an example 600 of the mobile device 510 receiving another push notification 620 based on another micro-location, according to an embodiment. In this example, the mobile device 510 is with a user that is visiting a retail establishment, “Big Store” 630. While the user is visiting the Electronics Department 640 the user pulls out the mobile device 510 from his/her pocket, which triggers an event for receiving the impression of a real-time push notification 620. The mobile device 510 receives a push notification 620 based on BLE event data based on nearby beacons, which is in the Electronics Department. The example message (i.e., the initial notification) is updated to state: “A Special Thanks; To thank you for visiting Big Store Electronics Department 640 (the placeholder has now been updated for the current zone the mobile device visits), please accept 20% off todays purchases.” The user may select OK or Cancel on the push notification 620.

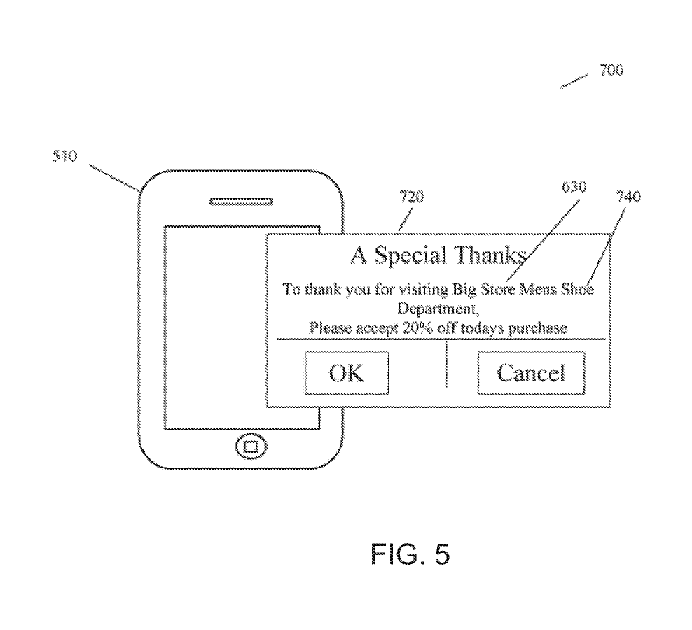

FIG. 5 shows an example 700 of the mobile device 510 receiving yet another push notification 720 based on an action with the mobile device 510 and yet another micro-location, according to an embodiment. In this example, the mobile device 510 is with a user that is visiting the retail establishment, “Big Store” 630. While the user is visiting the Men's Shoe Department 740 the user pulls out the mobile device 510 from his/her pocket, which triggers an event for receiving the impression of a real-time push notification 720. The mobile device 510 receives the push notification 720 based on BLE event data based on nearby beacons, which is in the Men's Shoe Department. The push notification is updated to the new example message “A Special Thanks; To thank you for visiting Big Store Men's Shoe Department 740 (the placeholder has now been updated for the current zone the mobile device visits), please accept 20% off todays purchases.” The user may select OK or Cancel on the push notification 720.

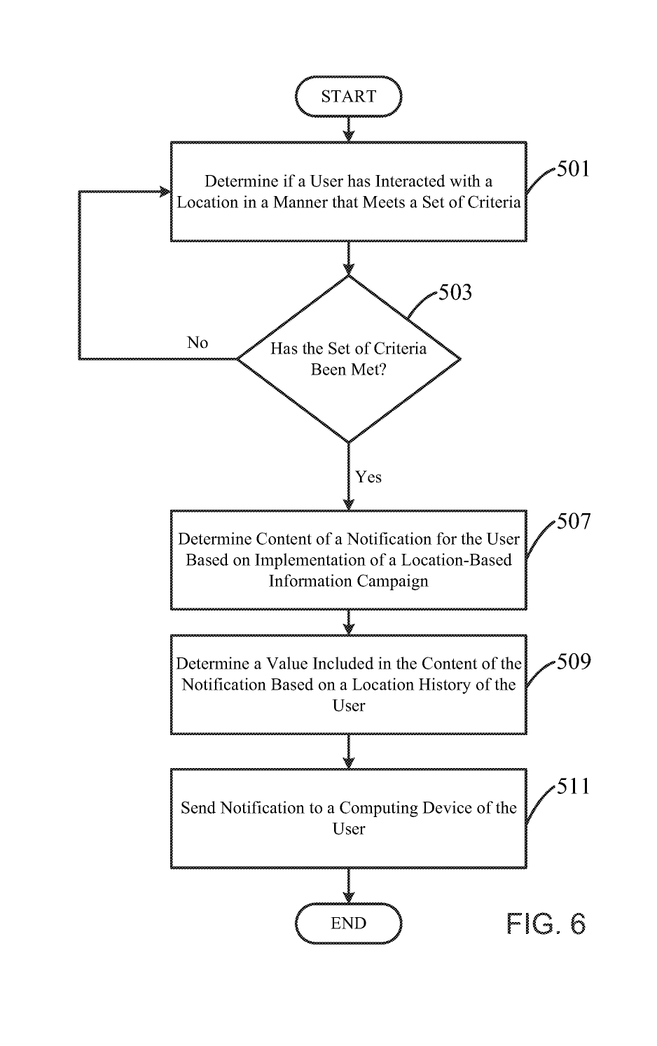

FIG. 6 illustrates an example process of sending a customized notification based on location based information, in accordance with embodiments of the present invention. In step 501, it is determined if a user has interacted with a location in a manner that meets a set of criteria. For example, in embodiments, the criteria may be the number of times the user has entered the location within a first period of time. In other embodiments, the criteria may include a timestamp that indicates a promotion offer was redeemed by the user. In embodiments, the criteria includes an object (e.g. clothes, accessories, fashion items, consumer goods, consumables, etc.) in possession of the user when they enter the location. In embodiments, the object in possession of the user is an indicator of the user's shopping habits.

In decision block 503, in response to the determination in step 501, it may be determined if the set of criteria has been met. If the criteria has not been met, then decision block 503 leads back to step 501 in a loop until it is determined that criteria has been met. If the criteria has been met, then decision block 503 leads to step 507 to determine content of a notification for the user based on implantation of a location based information campaign. In embodiments, characteristics of a group of users may be used to determine the content of the notification. For example, in embodiments, the content of the notification is uniform across the group of user. In embodiments, for example, the content of the notification may be harmonized across the group of users.

After determining the content of a notification 507, in step 509, a value included in the content of the notification is determined based on a location history of the user. In embodiments, the content of the location-based information campaign is based on a customer award program. In embodiments, the content of the location-based information campaign is based on consuming habits of a group of users. In embodiments, the content of the location-based information campaign is based on social media data of the group of users.

In step 511, a notification may be sent to a computing device of a user, in accordance with embodiments. Although embodiments relate to a notification to a computing device, the spirit of the invention is not limited to any particular form of notification or communication system.

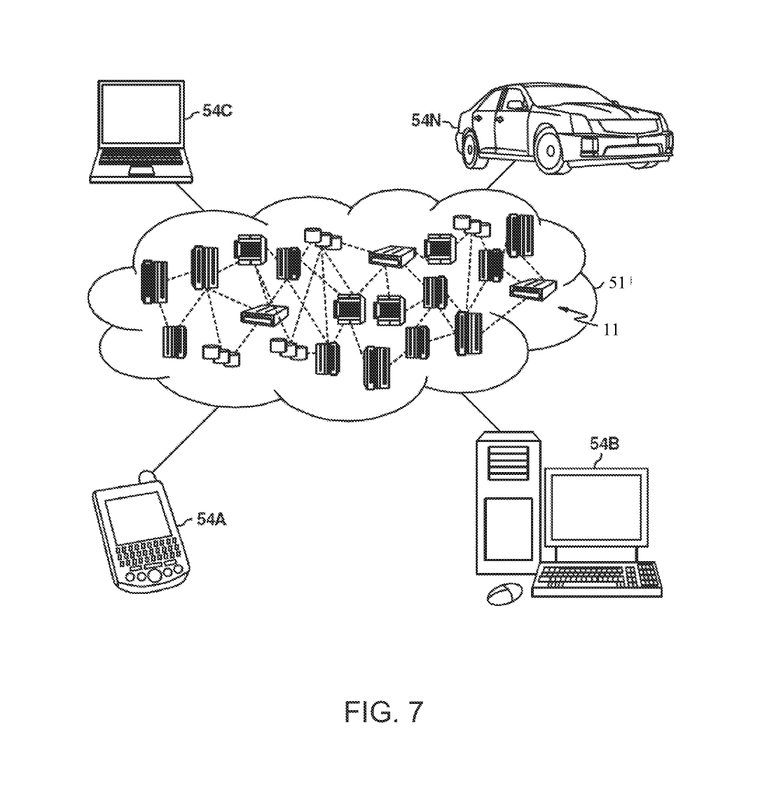

FIG. 7 depicts a cloud computing environment according to embodiments of the present invention. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

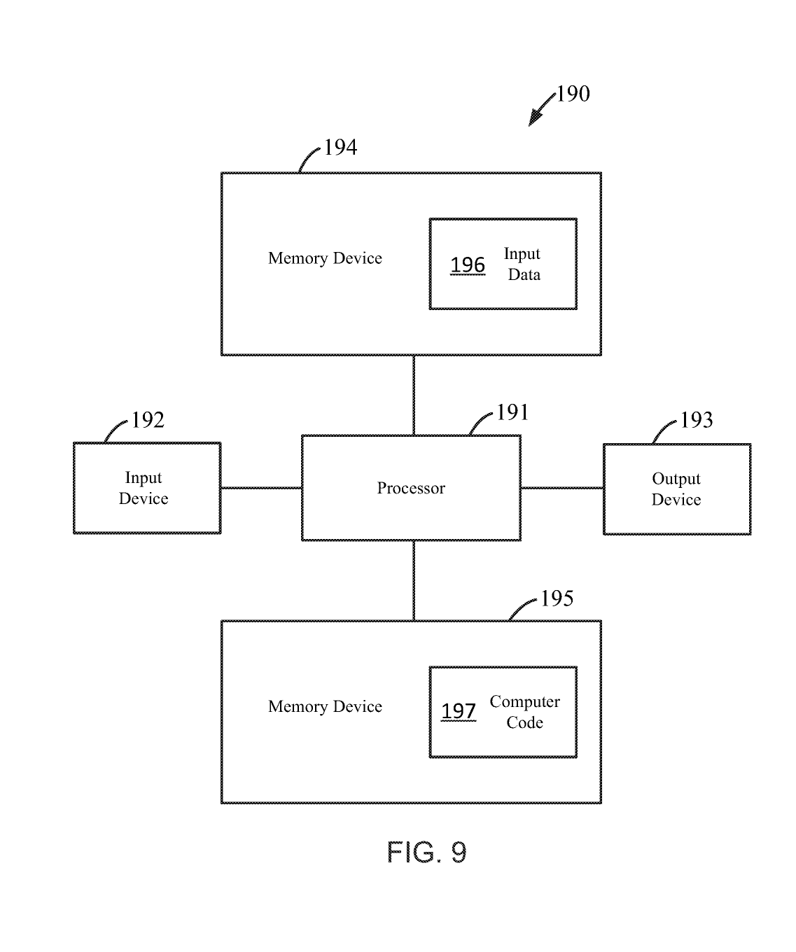

Referring now to FIG. 7, illustrative cloud computing environment 51 is depicted. As shown, cloud computing environment 51 includes one or more cloud computing nodes 11 with which local computing devices used by cloud consumers, such as, for example, personal digital assistant (PDA) or cellular telephone 54A, desktop computer 54B, laptop computer 54C, and/or automobile computer system 54N may communicate. Nodes 11 may communicate with one another. They may be grouped (not shown) physically or virtually, in one or more networks, such as Private, Community, Public, or Hybrid clouds as described hereinabove, or a combination thereof. This allows cloud computing environment 51 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 51 can communicate with any type of computerized device over any type of network and/or network addressable connection (e.g., using a web browser).

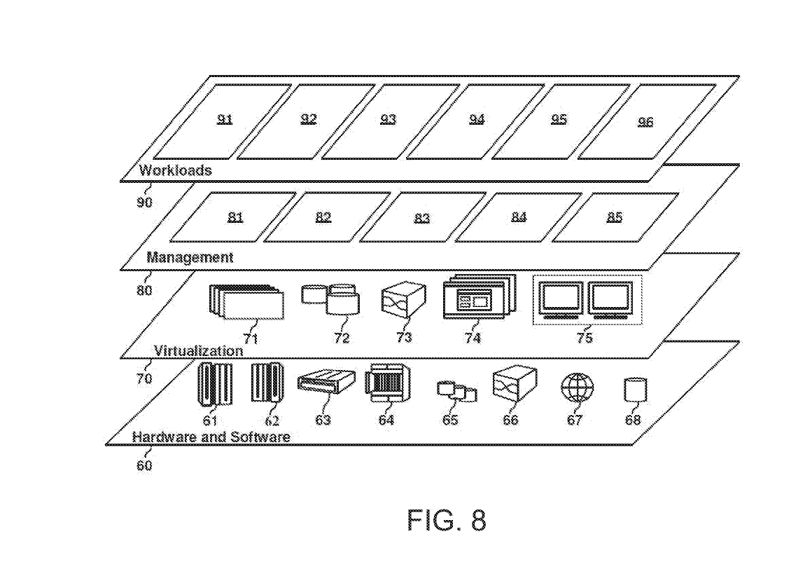

Referring now to FIG. 8, a set of functional abstraction layers provided by cloud computing environment 51 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and determining content of a notification for the user based in part on the user meeting the set of criteria in an implementation of a location-based information campaign and determining a value included in the content of the notification based, at least in part, on a location history of the user 96.

FIG. 9 illustrates a computer system 190 used for implementing the methods of the present invention. The computer system 190 includes a processor 191, an input device 192 coupled to the processor 191, an output device 193 coupled to the processor 191, and memory devices 194 and 195 each coupled to the processor 191. The input device 192 may be, inter alia, a keyboard, a mouse, etc. The output device 193 may be, inter alia, a printer, a plotter, a computer screen, a magnetic tape, a removable hard disk, a floppy disk, etc. The memory devices 194 and 195 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 195 includes a computer code 197 which is a computer program that includes computer-executable instructions. The computer code 197 includes software or program instructions that may implement an algorithm for implementing methods of embodiments of the present invention. The processor 191 executes the computer code 197. The memory device 194 includes input data 196. The input data 196 includes input required by the computer code 197. The output device 193 displays output from the computer code 197. Either or both memory devices 194 and 195 (or one or more additional memory devices not shown in FIG. 9) may be used as a computer usable storage medium (or program storage device) having a computer readable program embodied therein and/or having other data stored therein, wherein the computer readable program includes the computer code 197. Generally, a computer program product (or, alternatively, an article of manufacture) of the computer system 190 may include the computer usable storage medium (or said program storage device).

The processor 191 may represent one or more processors. The memory device 194 and/or the memory device 195 may represent one or more computer readable hardware storage devices and/or one or more memories.

Thus embodiments of the present invention discloses a process for supporting, deploying and/or integrating computer infrastructure, integrating, hosting, maintaining, and deploying computer-readable code into the computer system 190, wherein the code in combination with the computer system 190 is capable of implementing the methods of embodiments of the present invention.

While FIG. 9 shows the computer system 190 as a particular configuration of hardware and software, any configuration of hardware and software, as would be known to a person of ordinary skill in the art, may be utilized for the purposes stated supra in conjunction with the particular computer system 190 of FIG. 9. For example, the memory devices 194 and 195 may be portions of a single memory device rather than separate memory devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A computer program product of embodiments may include one or more computer readable hardware storage devices having computer readable program code stored therein, said program code containing instructions executable by one or more processors of a computing system (or computer system) to implement the methods of the present invention.

A computing system (or computer system) of embodiments may include one or more processors, one or more memories, and one or more computer readable hardware storage devices, said one or more hardware storage devices containing program code executable by the one or more processors via the one or more memories to implement the methods of embodiments.

In embodiments, the computer or computer system may be or include a special-purpose computer or machine that comprises specialized, non-generic hardware and circuitry (i.e., specialized discrete non-generic analog, digital, and logic based circuitry) for (independently or in combination) particularized for executing only methods of the present invention. The specialized discrete non-generic analog, digital, and logic based circuitry may include proprietary specially designed components (e.g., a specialized integrated circuit, such as for example an Application Specific Integrated Circuit (ASIC), designed for only implementing methods of the present invention).

In embodiments, sending notifications may be implemented using special purpose algorithms. For example, a special purpose algorithm may be implemented to determine content of a notification for the user based in part on the user meeting the set of criteria in an implementation of a location-based information campaign and determining a value included in the content of the notification based, at least in part, on a location history of the user.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of sending notifications, the method comprising:
determining that a user has interacted with a location in a manner that meets a set of criteria;
based, at least in part, on a determination that the user has interacted with the location, determining content of a notification for the user based in part on the user meeting the set of criteria in an implementation of a location-based information campaign;
determining a value included in the content of the notification based, at least in part, on a location history of the user; and
sending the notification to a computing device of the user.

2. The method of claim 1, wherein the location history of the user comprises a number of times the user has entered the location within a first time period.

3. The method of claim 1, wherein the location history of the user comprises a timestamp that indicates a promotion offer was redeemed by the user.

4. The method of claim 1, wherein the location history of the user comprises an object in possession of the user when they entered the location.

5. The method of claim 4, wherein the object in possession of the user is an indicator of the user's shopping habits.

6. The method of claim 4, wherein the object in possession is selected from a group consisting of:
clothes;
accessories;
fashion items;
consumer goods;
consumables; and
combinations thereof.

7. The method of claim 1, wherein the location history of the user comprises characteristics of a group of users that includes the user.

8. The method of claim 7, wherein the characteristics of the group of users is used in the determining the content of the notification.

9. The method of claim 8, wherein the content of the notification is uniform content across the group of users.

10. The method of claim 8, wherein the content of the notification is harmonized across the group of users.

11. The method of claim 8, wherein the content of the location-based information campaign is based on a customer award program.

12. The method of claim 8, wherein the content of the location-based information campaign is based on consuming habits of the group of users.

13. The method of claim 8, wherein the content of the location-based information campaign is based on social media data of the group of users.

14. The method of claim 1, wherein the location history comprises a number of people the user has referred to a venue.

15. The method of claim 1, wherein the location is a targeting notification area.

16. The method of claim 1, wherein the notification is personalized to the user based on the location history of the user.

17. The method of claim 16, wherein the notification is personalized to include a discount rate determined at least in part on the location history of the user.

18. The method of claim 1, wherein the location includes a customer analysis system configured to at least partially generate the location history of the user.

19. A computer system comprising:
a central processing unit (CPU);
a memory coupled to the CPU; and
a computer readable storage device coupled to the CPU, the storage device containing instructions that are executed by the CPU via the memory to implement a method that determines an optimal number of data centers for an application, the method comprising the steps of:
determining that a user has interacted with a location in a manner that meets a set of criteria;
based, at least in part, on a determination that the user has interacted with the location, determining content of a notification for the user based in part on the user meeting the set of criteria in an implementation of a location-based information campaign;
determining a value included in the content of the notification based, at least in part, on a location history of the user; and
sending the notification to a computing device of the user.

20. A computer program product, comprising a computer readable hardware storage device having computer readable program code stored therein, said program code containing instructions executable by one or more processors of a computer system to implement a method of assessing damage to an object, said method comprising:
determining that a user has interacted with a location in a manner that meets a set of criteria;
based, at least in part, on a determination that the user has interacted with the location, determining content of a notification for the user based in part on the user meeting the set of criteria in an implementation of a location-based information campaign;
determining a value included in the content of the notification based, at least in part, on a location history of the user; and
sending the notification to a computing device of the user.
